(19) United States
(12) Patent Application Publication
(10) Pub. No.: US 2021/0007140 A1
(43) Pub. Date: Jan. 7, 2021

(54) TRANSMISSION APPARATUS AND RECEPTION APPARATUS

(71) Applicant: NTT DOCOMO, INC., Tokyo (JP)

(72) Inventors: Daisuke Murayama, Tokyo (JP); Hiroki Harada, Tokyo (JP); Kazuaki Takeda, Tokyo (JP); Satoshi Nagata, Tokyo (JP)

(73) Assignee: NTT DOCOMO, INC., Tokyo (JP)

(21) Appl. No.: 16/969,235

(22) PCT Filed: Feb. 16, 2018
(86) PCT No.: PCT/JP2018/005558

§ 371 Date: Aug. 12, 2020

(51) Int. Cl. H04W 74/08; H04W 72/04; H04W 74/00

(52) U.S. Cl. CPC H04W 74/0808; H04W 74/006; H04W 72/0453; H04W 72/042

(57) ABSTRACT

A transmitting apparatus that transmits data in a first frequency band is provided with a transmitting section that transmits a transmission request signal of the data in the first frequency band, a receiving section that receives a response signal to the transmission request signal in a second frequency band, and a control section that controls transmission of the data based on the response signal.

### TECHNICAL FIELD

The present invention relates to a transmitting apparatus and receiving apparatus in the next-generation mobile communication system.

### BACKGROUND ART

In UMTS (Universal Mobile Telecommunications System) networks, for the purpose of higher data rates, low delay and the like, Long Term Evolution (LTE) has been specified (Non-patent Document 1). Further, for the purpose of wider bands and higher speed than LTE, successor systems (e.g., also referred to as LTE-A (LTE-Advanced), FRA (Future Radio Access), 4G, 5G, 5G+ (plus), NR (New RAT), 3GPP (3^{rd} Generation Partnership Project), Rel.14, 15, 16˜, etc.) to LTE have also been studied.

In the existing LTE system (e.g., Rel.8-12), standardization has been carried out on the assumption that exclusive operation is performed in a frequency band (also referred to as a licensed band, licensed carrier, licensed component carrier (CC), etc.) licensed to a network operator. As the licensed CC, for example, 800 MHz, 1.7 GHz, 2 GHz and the like are used.

Further, in the existing LTE system (e.g., Rel.13), in order to extend the frequency band, use is supported in a frequency band (also referred to as an unlicensed band, unlicensed carrier, unlicensed CC) different from the above-mentioned licensed band. As the unlicensed band, for example, 2.4 GHz-band, 5 GHz-band and the like are assumed where it is possible to use Wi-Fi (Registered Trademark) and Bluetooth (Registered Trademark).

Specifically, Rel.13 supports Carrier Aggregation (CA) to integrate carriers (CCs) of the licensed band and carriers (CCs) of the unlicensed band. Communication performed by thus using the unlicensed band together with the licensed band is referred to as LAA (License-Assisted Access).

Use of LAA has been studied also in future radio communication systems (e.g., 5G, 5G+, NR, Rel.15 onward). In the future, there is a possibility that Dual Connectivity (DC) of the licensed band and the unlicensed band and Stand-Alone (SA) of the unlicensed band are also study targets for LAA.

### PRIOR ART DOCUMENT

### Non-Patent Document

[Non-patent Document 1] 3GPP TS 36.300 V.8.12.0 “Evolved Universal Terrestrial Radio Access (E-UTRA) and Evolved Universal Terrestrial Radio Access Network (E-UTRAN); Overall description; Stage 2 (Release 8)”, April 2010

### Disclosure of Invention

### Problems to be Solved by the Invention

In LAA of the existing LTE system (e.g., Rel.13), a transmitting apparatus (for example, radio base station for transmitting downlink data and/or user terminal for transmitting uplink data) performs listening (also called LBT: Listen Before Talk, CCA: Clear Channel Assessment, carrier sense, channel access operation: channel access procedure, or the like) to ascertain the presence or absence of transmission of another apparatus (e.g., radio base station, user terminal, Wi-Fi apparatus, etc.), before transmitting data in the unlicensed band.

The transmitting apparatus starts data transmission after a predetermined period (immediately after or period of back-off) since the absence of transmission of another apparatus (idlest ate) is detected in listening. However, also in the case where the transmitting apparatus transmits data based on a result of the listening, there is the risk that a collision between data is not avoided in the receiving apparatus (e.g., user terminal for receiving downlink data and/or radio base station for receiving uplink data).

The present invention was made in view of such a respect, and it is an object of the invention to provide a transmitting apparatus and receiving apparatus capable of improving an avoidance rate of collision between data in the future LAA system.

### Means for Solving the Problem

One aspect of a transmitting apparatus of the present invention is a transmitting apparatus that transmits data in a first frequency band, and is characterized by being provided with a transmitting section that transmits a transmission request signal of the data in the first frequency band, a receiving section that receives a response signal to the transmission request signal in a second frequency band, and a control section that controls transmission of the data based on the response signal.

One aspect of a receiving apparatus of the present invention is a receiving apparatus that receives data in a first frequency band, and is characterized by being provided with a transmitting section that transmits a response signal to the signal request signal in a second frequency band, in the case of normally receiving the transmission request signal in the first frequency band or in the case of detecting an idle state in listening in the first frequency band.

### Advantageous Effect of the Invention

According to the present invention, it is possible to improve the avoidance rate of collision between data in the future LAA system.

### BRIEF DESCRIPTION OF DRAWINGS

FIG. 1 is a diagram showing one example of a collision between data by a hidden terminal;

FIG. 2 is a diagram showing one example of CSMA/CA with RTS/CTS;

FIG. 3 is a diagram showing one example of RTS/CTS in a future LAA system;

FIG. 4 is a diagram showing one example of downlink data collision control according to Aspect 1;

FIGS. 5A to 5C are diagrams showing one example of first to third RTS transmission control according to Aspect 1;

FIG. 6 is a diagram showing one example of second RTS response control according to Aspect 1;

FIGS. 7A and 7B are diagrams showing one example of formats of RTS and RTS response signal according to Aspect 1;

FIG. 8 is a diagram showing one example of a schematic configuration of a radio communication system according to this Embodiment;

FIG. 9 is a diagram showing one example of a function configuration of a radio base station according to this Embodiment;

FIG. 10 is a diagram showing one example of a function configuration of a baseband signal processing section of the radio base station;

FIG. 11 is a diagram showing one example of a function configuration of a user terminal according to this Embodiment;

FIG. 12 is a diagram showing one example of a function configuration of a baseband signal processing section of the user terminal; and

FIG. 13 is a diagram showing one example of hardware configurations of the radio base station and user terminal according to one Embodiment of the present invention.

### BEST MODE FOR CARRYING OUT THE INVENTION

In an unlicensed band (e.g., 2.4 GHz-band and 5 GHz-band), for example, since it is expected that a plurality of systems coexists such as a Wi-Fi system and a system (LAA system) for supporting LAA, it is conceivable that the need arises for collision avoidance of transmission and/or interference control among the plurality of systems.

For example, in the Wi-Fi system using the unlicensed band, for the purpose of collision avoidance and/or interference control, CSMA (Carrier Sense Multiple Access)/CA (Collision Avoidance) is adopted. In CSMA/CA, a predetermined time (DIFS: Distributed access Inter Frame Space) is provided before transmission, and after confirming (carrier sense) the absence of another transmission signal, the transmitting apparatus performs data transmission. Further, after transmitting the data, the transmitting apparatus waits for ACK (ACKnowledgement) from the receiving apparatus. In the case that the transmitting apparatus is not able to receive ACS within a predetermined time, the transmitting apparatus determines that a collision occurs, and performs retransmission.

Further, in the Wi-Fi system, for the purpose of collision avoidance and/or interference control, RTS (Request to Send)/CTS (Clear to Send) is adopted where a transmission request (RTS) is transmitted before transmission, and when the receiving apparatus is capable of receiving, the apparatus responses with CTS. For example, the RTS/CTS is effective in collision avoidance of data by a hidden terminal.

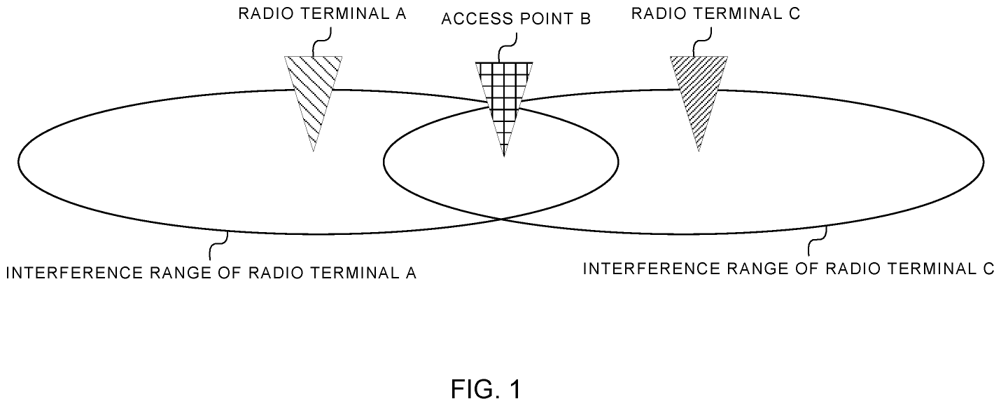

FIG. 1 is a diagram showing one example of a collision between data by a hidden terminal. In FIG. 1, since a radio wave of a radio terminal C does not reach a radio terminal A, even when the radio terminal A performs carrier sense before transmission, the terminal A is not able to detect a transmission signal from the radio terminal C. As a result, also during transmission from the radio terminal B to an access point B, it is expected that the radio terminal A also performs transmission to the access point B. In this case, transmission signals from the radio terminals A and C collide with each other in the access point B, and there is the risk that throughput deteriorates.

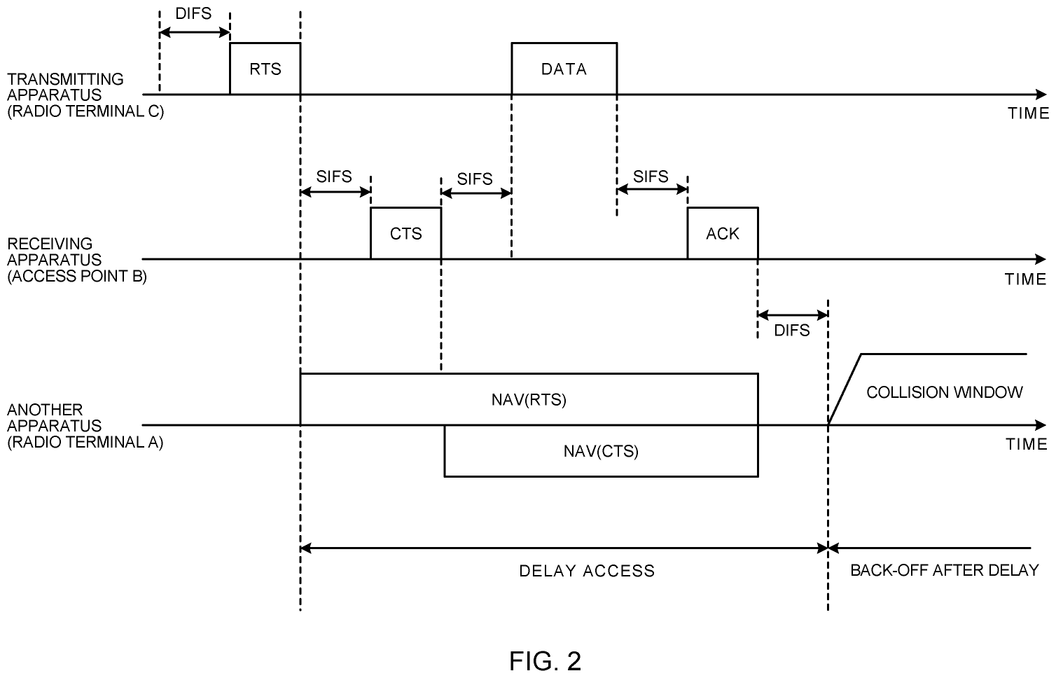

FIG. 2 is a diagram showing one example of CSMA/CA with RTS/CTS. As shown in FIG. 2, when the radio terminal C (transmitting side) ascertains that another transmission signal does not exist in a predetermined time (DIFS) before transmission, the terminal C transmits RTS (in addition, in FIG. 1, the RTS does not reach the radio terminal A (another terminal.) Upon receiving the RTS from the radio terminal C, the access point B (receiving side) transmits CTS after a predetermined time (SIFS: Short Inter Frame Space).

In FIG. 2, since the CTS from the access point B reaches also the radio terminal A (another apparatus), the terminal A senses that communication is performed, and postpones transmission. In a packet of RTS/CTS, a predetermined period (also referred to as NAV: Network Allocation Vector, transmission prohibition period or the like) is described, and therefore, the terminal A reserves transmission during the predetermined period.

Upon receiving the CTS from the access point B, the radio terminal C ascertains that another transmission signal does not exist in the predetermined period (SIFS) before transmission, and then, transmits data (frame) after the predetermined period (SIFS). Upon receiving the data, the access point B transmits ACK after the predetermined period (SIFS).

In FIG. 2, when the radio terminal A that is the hidden terminal of the radio terminal C detects the CTS from the access point B, the terminal A postpones transmission, and it is thereby possible to avoid a collision between transmission signals from the radio terminals A and C in the access point B.

In addition, in LAA of the existing LTE system (e.g., Rel.13), a transmitting apparatus (e.g., radio base station for transmitting downlink data and/or user terminal for transmitting uplink data) performs listening (also called LBT, CCA, carrier sense, channel access operation or the like) to ascertain the presence or absence of transmission of another apparatus (e.g., radio base station, user terminal, Wi-Fi apparatus, etc.), before transmitting data in the unlicensed band.

The transmitting apparatus starts data transmission after a predetermined period (immediately after or period of back-off) since the absence of transmission of another apparatus (idlest ate) is detected in listening. However, also in the case where the transmitting apparatus transmits data based on a result of the listening, as a result of existence of the above-mentioned hidden terminal, there is the risk that a collision between data is not avoided in the receiving apparatus (e.g., user terminal for receiving downlink data and/or radio base station for receiving uplink data).

Therefore, in future LAA systems (e.g., also referred to as Rel.15 onward, 5G, 5G+, NR or the like), in order to improve an avoidance rate of collision between data in the receiving apparatus, it is studied to support the above-mentioned RTS/CTS.

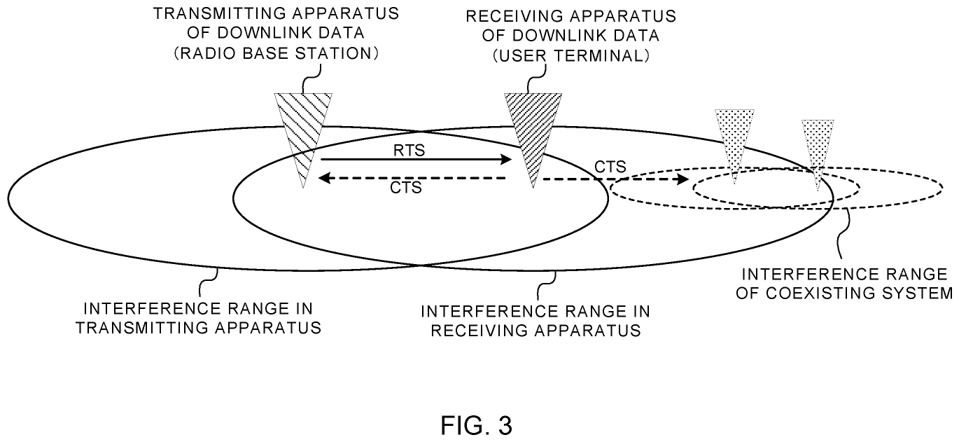

FIG. 3 is a diagram showing one example of RTS/CTS in the future LAA system. As shown in FIG. 3, in the future LAA system for supporting RTS/CTS, it is expected that a transmitting apparatus (radio base station) transmits RTS in a carrier (also referred to as an unlicensed carrier, unlicensed CC, LAA SCell (Secondary Cell), etc.) of an unlicensed band before transmitting downlink data to a receiving apparatus (user terminal).

On the other hand, it is also expected that the future LAA system does not support an uplink unlicensed CC. In the case of not supporting the unlink unlicensed CC, a receiving apparatus (user terminal) of downlink data is not able to transmit CTS, and there is the risk that it is not possible to support the above-mentioned RTS/CTS.

Further, in the case of supporting the unlink unlicensed CC in the future LAA system, as shown in FIG. 3, when the receiving apparatus (user terminal) of downlink data transmits CTS using the uplink unlicensed CC, there is the risk that the CTS imposes unnecessary interference on another apparatus (e.g., another apparatus in the LAA system, or an apparatus of another coexisting system (e.g., Wi-Fi system)).

Therefore, the inventors of the present invention conceived actualization of collision control equivalent to the above-mentioned RTS/CTS, while reducing interference imposed by CTS transmission, by transmitting a signal that corresponds to the above-mentioned CTS in a licensed CC as a substitute for an unlicensed CC in the above-mentioned future LAA system.

This Embodiment will be described below in detail with reference to accompanying drawings. In this Embodiment, an unlicensed CC may be read with a carrier (cell, CC) of a first frequency band, carrier (cell, CC) of an unlicensed band, LAA SCell and the like. Further, a licensed CC may be read with a carrier (cell, CC) of a second frequency band, carrier (cell, CC) of a licensed band, PCell (Primary Cell), SCell and the like.

### (Aspect 1)

Aspect 1 describes collision control at the time of downlink data transmission. In Aspect 1, it is assumed that a transmitting apparatus is a radio base station (e.g., gNB: gNodeB, transmission and reception point (TRP), transmission point), and that a receiving apparatus is a user terminal (e.g., UE: User Equipment).

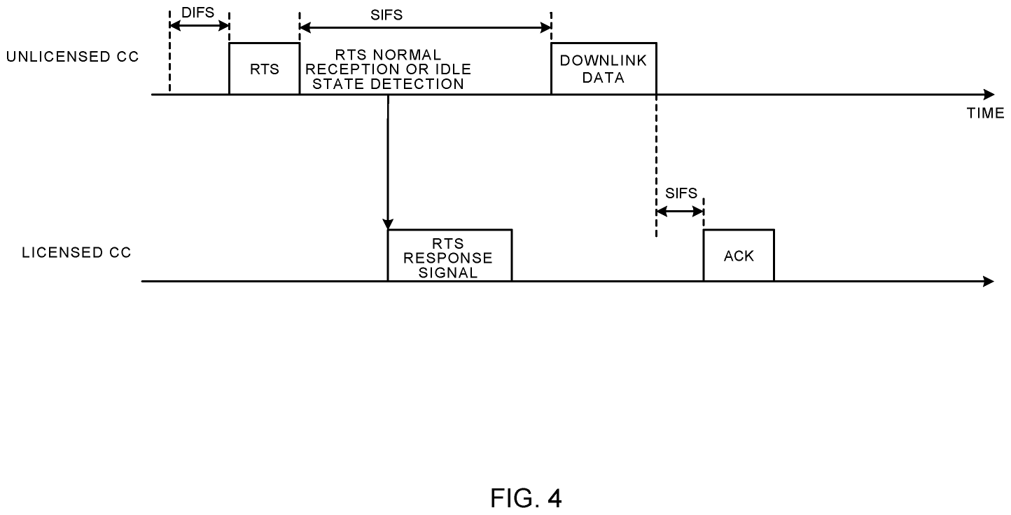

FIG. 4 is a diagram showing one example of downlink data collision control according to Aspect 1. In FIG. 4, as an example, the case is described where using a carrier (also referred to as an unlicensed CC, LAA SCell: LAA Secondary Cell, or the like) of an unlicensed band, the radio base station transmits downlink data to the user terminal.

As shown in FIG. 4, in the unlicensed CC, the radio base station performs listening (carrier sense) in a predetermined period (DIFS) before transmission, and in the case of an idle state, transmits CTS. The predetermined period is also called an LBT period, listening period, carrier sense period and the like, and may include a period for back-off.

The RTS may be transmitted (transmitted omnidirectionally) to the entire cell of the unlicensed CC, or may be transmitted in a predetermined direction using beam forming (BF). The RTS may be RTS (FIG. 2) of the Wi-Fi system, may be a signal in conformity with IEEE 802.11, or may be a signal specific to the LAA system. The RTS is essentially a signal (transmission request signal) for requesting transmission of a downlink signal, or a signal (transmission notification signal) for notifying of transmission of a downlink signal.

In the unlicensed CC, in the case of normally receiving the RTS to the user terminal, or in the case where the user terminal performs listening (carrier sense) in a predetermined period (SIFS) prior to transmission and is in an idle state, the terminal transmits a response signal (RTS response signal) to the RTS using the licensed CC. The predetermined period is also called the LBT period, listening period, carrier sense period and the like, and may be shorter than the above-mentioned DIFS. In addition, the carrier sense may be performed after normally receiving the RTS to the user terminal.

The RTS response signal is a signal substituting for the above-mentioned CTS (FIG. 2). The RTS response signal is also referred to as a signal (transmission permitting signal) for permitting transmission of downlink data, or a signal (reception allowing signal) for notifying of allowing downlink data to be received.

The RTS response signal (frame for the RTS response signal) may be transmitted using an uplink control channel (e.g., PUSCH: Physical Uplink Control Channel), and uplink shared channel (e.g., PUSCH: Physical Uplink Shared Channel). The PUSCH may be a PUSCH dynamically scheduled by downlink control information (DCI, UL grant), or a PUSCH (grant-free PUSCH) configured semi-statically by higher layer signaling (e.g., RRC signaling) without scheduling by the UL grant.

Upon receiving the RTS response signal in the licensed CC, the radio base station transmits downlink data in the unlicensed CC within the predetermined period (SIFS) after RTS transmission. The downlink data (frame for the downlink data) maybe transmitted using a downlink shared channel (e.g., PDSCH: Physical Downlink Shared Channel).

Upon succeeding in decoding the downlink data transmitted in the unlicensed CC, the user terminal may transmit ACK using the licensed CC after the predetermined period (SIFS).

As shown in FIG. 4, in the case where the user terminal transmits the RTS response signal using the licensed CC, the radio base station is capable of confirming that the hidden terminal (e.g., another radio base station for transmitting downlink data to the user terminal, another system providing radio wave interference, etc.) does not exist.

Accordingly, in FIG. 4, also when uplink transmission in the unlicensed CC is not supported, it is possible to enhance the avoidance rate of signal collision (e.g., collision between downlink signals from a plurality of radio base stations) in the user terminal. Further, in FIG. 4, in the case of supporting uplink transmission in the unlicensed CC, since it is possible to eliminate imposed interference due to CTS transmission by the user terminal in the unlicensed CC, it is possible to improve space usage efficiency in the unlicensed CC.

### <RTS Transmission Control>

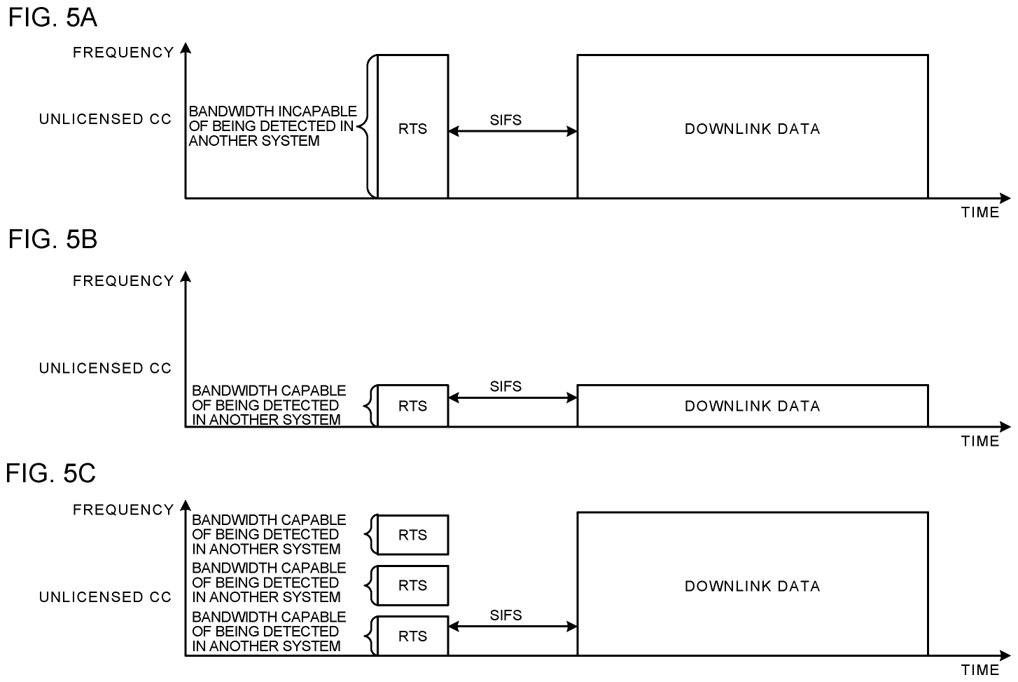

One example of first to third transmission control (RTS transmission control) of RTS according to Aspect 1 will be described with reference to FIGS. 5A to 5C.

As shown in FIG. 5A, in first RTS transmission control, the radio base station may transmit the RTS in a bandwidth (frequency band) that is at least a part of a transmission bandwidth (frequency band) of downlink data in the unlicensed CC. For example, in FIG. 5A, the bandwidth equal to the transmission bandwidth of downlink data is used in transmission of RTS.

In FIG. 5A, the transmission bandwidth of the RTS and/or downlink data may be different from (wider than or narrower than) a bandwidth of a channel of another system (e.g., Wi-Fi system, IEEE 801.11). By making the transmission bandwidth of the RTS and/or downlink data different from that of another system, it is made possible to receive the RTS and/or downlink data only by the LAA system. Thus, the RTS in FIG. 5A is not detected by the another system, and therefore, may be a transmission request signal or transmission notification signal specific to the LAA system.

On the other hand, in second and third RTS transmission control shown in FIGS. 5B and 5C, the RTS may be RTS (transmission request signal or transmission notification signal) in conformity with another system (e.g., Wi-Fi system, IEEE 802.11) coexisting with the LAA system. For example, the “RTS in conformity with another system” may be the same as the RTS of another system in at least one of subcarrier spacing, channel grid, format and transmission bandwidth.

As shown in FIG. 5B, in second RTS transmission control, in the unlicensed CC, the radio base station transmits a single RTS in conformity with another system, and may transmit downlink data in at least a part of the transmission bandwidth (frequency band) of the single RTS. For example, in FIG. 5B, the same bandwidth as the transmission bandwidth of the single RTS is used in transmission of the downlink data.

In FIG. 5B, since the single RTS in conformity with another system is transmitted in the bandwidth (e.g., channel for the Wi-Fi system) capable of being detected by the another system, not only within the LAA system, it is possible to perform overall collision avoidance control but also between the LAA system and another system coexisting in the unlicensed band.

Further, as shown in FIG. 5C, in third RTS transmission control, in the unlicensed CC, the radio base station may frequency-multiplex a plurality of RTSs in conformity with another system to transmit. The plurality of RTSs may be transmitted in a vacant band of the unlicensed CC. For example, in FIG. 5C, the radio base station transmits three RTSs on three channels for the Wi-Fi system where the idle state is detected by listening.

In FIG. 5C, the radio base station may transmit downlink data in at least a part of the total transmission bandwidth (frequency band) of the plurality of RTSs. For example, in FIG. 5C, the same bandwidth as the total transmission bandwidth of three RTSs is used in transmission of the downlink data. In addition, it is assumed that three RTSs shown in FIG. 5C are transmitted using three contiguous channels in the frequency domain, but at least one RTS may be transmitted using a discontiguous channel.

In FIG. 5C, since each of a plurality of RTSs in conformity with another system is transmitted in a bandwidth capable of being detected by the another system, it is possible to perform overall collision avoidance control between the LAA system and the another system. Further, in FIG. 5C, since the downlink data is transmitted in the total transmission bandwidth of the plurality of RTSs, it is possible to maintain throughput of the downlink data in the LAA system.

### <RTS Response Control>

One example of first and second response control (RTS response control) to the RTS according to Aspect 1 will be described with reference to FIGS. 4 to 6. In first RTS response control, the case is assumed that a single RTS is transmitted in the unlicensed CC. On the other hand, in second RTS transmission control, the case is assumed that a plurality of RTSs is transmitted in the unlicensed CC.

In first RTS response control, the case is assumed that a single RTS is transmitted in the unlicensed CC. As shown in FIG. 4, upon succeeding in receiving a single RTS in the unlicensed CC, the user terminal may transmit an RTS response signal using the licensed CC. In addition, in FIG. 4, the RTS and downlink data is essentially transmitted using the above-mentioned first RTS transmission control (FIG. 5A) or second RTS transmission control (FIG. 5B).

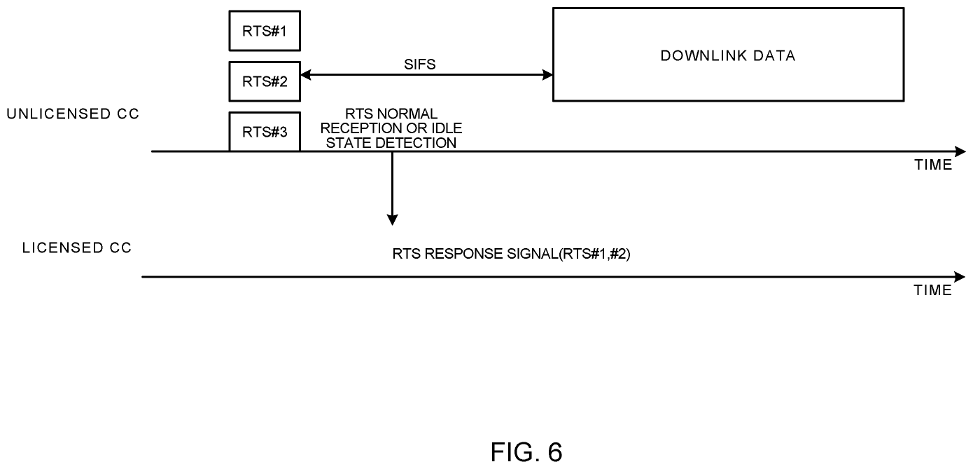

FIG. 6 is a diagram showing one example of second RTS response control according to Aspect 1. As shown in FIG. 6, in the case where the radio base station frequency-multiplexes a plurality of RTSs to transmit, each of the plurality of RTSs may be assigned with a number (also referred to as an RTS number, index, RTS index or the like) to identify the RTS.

In second RTS response control, the RTS response signal may include an RTS number succeeded in reception (decoding) among a plurality of frequency-multiplexed RTSs. For example, in FIG. 6, since the user terminal succeeds in receiving RTSs #1 and #2, the terminal transmits the RTS response signal including the RTS numbers #1 and #2 using the unlicensed CC.

Further, as shown in FIG. 6, using the total transmission bandwidth of one or more RTSs that the user terminal succeeds in receiving, the radio base station may transmit downlink data. For example, in FIG. 6, since the user terminal succeeds in receiving RTSs #1 and #2, the downlink data is transmitted in the bandwidth equal to the total transmission bandwidth of RTSs #1 and #2.

As shown in FIG. 6, in second RTS response control, the radio base station is capable of recognizing the RTS which the user terminal succeeds in receiving by the RTS number in the RTS response signal. Accordingly, the radio base station is capable of transmitting the downlink data in a band for enabling the user terminal to be received, and it is possible to improve at least one of spectral efficiency and space usage efficiency.

In addition, as a substitute for the RTS number of the RTS succeeded in reception, the RTS response signal may include a number (channel number) of a channel on which the RTS is transmitted. In this case, each RTS and channel number may be beforehand associated with each other, and each RTS may be transmitted using the channel with the corresponding channel number.

### <Format>

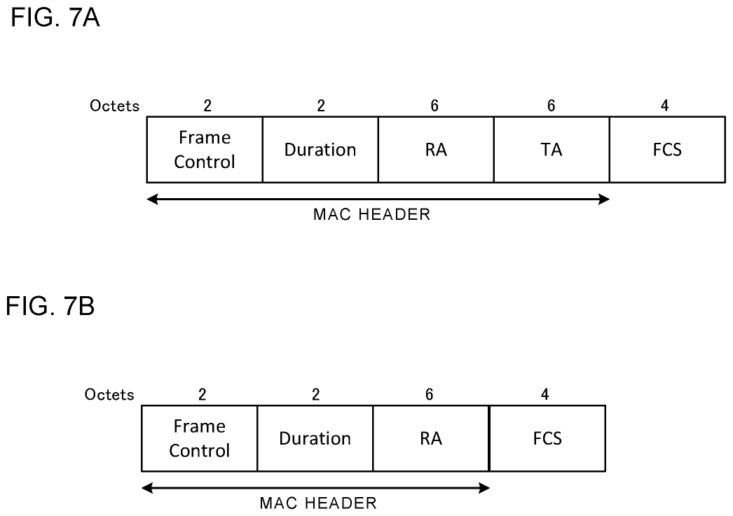

Formats (also referred to as signal formats, frame formats, etc.) of RTS and RTS response signal according to Aspect 1 will be described with reference to FIGS. 7A and 7B.

FIG. 7A shows one example of the RTS format in conformity with another system (e.g., IEEE 802.11). In FIG. 7A, a Duration region may indicate at least one of time required for transmission of data and data amount (the number of octets).

Further, an identifier (UE ID) of the user terminal may be stored in a region (RA (Receiver Address) region) for storing a MAC (Medium. Access Control) address on the receiving side. Furthermore, a cell identifier (cell ID) may be stored in a region (TA (Transmitter Address) region) for storing a MAC address on the transmitting side. Still furthermore, an RTS number may be stored in a part of the RA region or the TA region.

The RTS format shown in FIG. 7A may be used in the above-mentioned second and third RTS transmission control (FIGS. 5B and 5C). Further, in the above-mentioned first RTS transmission control (FIG. 5A), the RTS format shown in FIG. 7A may be used, or another RTS format may be used.

The another RTS format may include at least a region indicative of the RTS, region indicative of at least one of time required for data transmission and data amount, region for identifying a receiver, and a region for identifying a transmitter.

Further, the another RTS format may be DCI transmitted on a downlink control channel (e.g., PDCCH: Physical Downlink Control Channel). For example, the DCI (UL grant) for scheduling a PUSCH may be the above-mentioned another RTS format. In this case, the user terminal may transmit the RTS response signal using the PUSCH scheduled by the DCI.

FIG. 7B shows one example of a format (RTS response format) of the RTS response signal in conformity with another system (e.g., IEEE 802.11). In FIG. 7B, a Duration region may indicate at least one of time required for transmission of the data and data amount (the number of octets). An identifier (UE ID) of the user terminal may be stored in an RA region in FIG. 7B.

In the above-mentioned first RTS response control (FIG. 4), the RTS response format shown in FIG. 7B may be used, or another RTS response format may be used. In the above-mentioned second RTS response control (FIG. 6), another RTS format may be used.

For example, the another RTS format may include at least of each region shown in FIG. 7B, a region indicative of an RTS number with reception succeeded, and a region indicative of the RTS response signal.

### <Scheduling>

In the above-mentioned first and second RTS response control (FIGS. 4 and 6), the user terminal transmits the RTS response signal, using one of (1) PUSCH scheduled by UL grant, (2) PUSCH (PUSCH configured by higher layer signaling, grant-free PUSCH) without scheduling by UL grant, and (3) PUCCH.

(1) In the case of using the scheduled PUSCH, the radio base station may transmit a UL grant for scheduling a PUSCH of the licensed CC, after RTS transmission in the unlicensed CC. In addition, transmission of the UL grant may be performed concurrently with transmission of the RTS, may be performed after transmission of the RTS, or may be performed before transmission of the RTS in consideration of a processing speed of the user terminal.

Upon normally receiving the RTS, or detecting an idle state in the carrier sense, the user terminal transmits the RTS response signal using the PUSCH scheduled by the above-mentioned UL grant. In addition, the user terminal may start the above-mentioned carrier sense at the time of receiving the above-mentioned UL grant, or after normally receiving the RTS. Thus, by controlling transmission timing of the above-mentioned UL grant, the radio base station is capable of promptly receiving the RTS response signal, and of starting downlink data transmission within the predetermined period (SIFS) after RTS transmission.

On the other hand, (2) in the case of using the PUSCH without scheduling, or (3) the case of using the PUCCH, the radio base station may not transmit the above-mentioned UL grant.

<Handling of RTS that is not to the User Terminal>

In the above-mentioned first and second RTS response control (FIGS. 4 and 6), in the case of detecting an RTS that is not to the user terminal, the terminal may neglect the RTS not to transmit the RTS response signal.

Alternatively, in the case of detecting an RTS that is not to the user terminal and recognizing a start of data transmission to another apparatus, the terminal may halt transmission in the time indicated by the duration region of the RTS.

### <Application Control>

With respect to collision control at the time of downlink data transmission according to Aspect 1 as described above, whether or not to apply may be controlled, based on a detection frequency of a busy state on the transmitting side (radio base station) or the receiving side (user terminal).

Specifically, (1) in the case where the detection frequency of a busy state in carrier sense performed by the radio base station with predetermined periodicity is larger than a predetermined threshold (or the predetermined threshold or more), collision control at the time of downlink data transmission according to the above-mentioned Aspect 1 may be applied.

On the other hand, in the case where the above-mentioned detection frequency is the predetermined threshold or less (or smaller than the predetermined threshold), when an idle state is detected by LBT (listening, carrier sense) prior to transmission, the user terminal may start transmission of downlink data, without transmitting the RTS.

Alternatively, (2) in the case where the detection frequency of a busy state in carrier sense performed by the user terminal with predetermined periodicity is larger than a predetermined threshold (or the predetermined threshold or more), collision control at the time of downlink data transmission according to the above-mentioned Aspect 1 may be applied. In this case, the user terminal may report a result of carrier sense to the radio base station periodically. The report may be performed using the PUCCH or PUSCH of the licensed CC.

As described above, in the case of performing application control based on the detection frequency of a busy state on the transmitting side (radio base station) or the receiving side (user terminal), in an environment where the collision does not occur frequently, it is possible to omit transmission of RTS and RTS response signal, and to actualize improvements spectral efficiency and/or low latency transmission. Further, in the case based on the detection frequency of a busy state on the receiving side, when the busy degree is different between the receiving side and the transmitting side, it is possible to perform application control more properly.

### (Aspect 2)

Aspect 2 describes collision control at the time of uplink data transmission. In Aspect 2, it is assumed that a receiving apparatus is a radio base station (e.g., gNB: gNodeB, transmission and reception point (TRP), transmission point), and that a transmitting apparatus is a user terminal (e.g., UE: User Equipment).

In Aspect 2, the transmitting apparatus and receiving apparatus of Aspect 1 are essentially replaced with each other to apply Aspect 1 to collision control of an uplink data apparatus. Specifically, in Aspect 2, it is essential only that the “radio base station” of Aspect 1 is read with the “user terminal”, the “user terminal” of Aspect 1 read with the “radio base station”, and that the “downlink data” is read with the “uplink data”.

Further, in Aspect 2, the radio base station may transmit the above-mentioned RTS response signal (see FIGS. 4 and 6) using a downlink control channel (e.g., PDCCH) or a downlink shared channel (e.g., PDCCH).

### (Radio Communication System)

A configuration of a radio communication system according to this Embodiment will be described below. In the radio communication system, the radio communication method according to each of the above-mentioned Aspects is applied. In addition, the radio communication method according to each of the above-mentioned Aspects may be applied alone, or may be applied in combination.

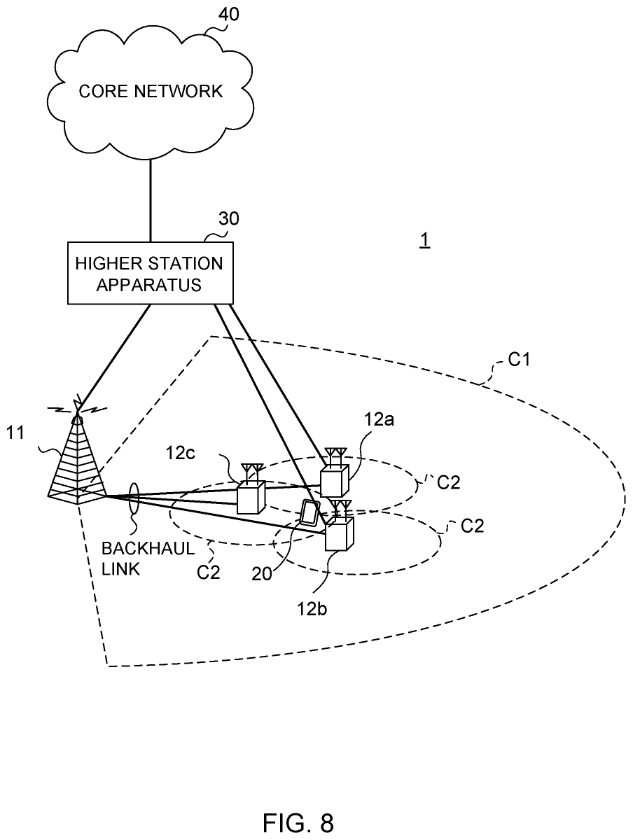

FIG. 8 is a diagram showing one example of a schematic configuration of the radio communication system according to this Embodiment. In the radio communication system 1, it is possible to apply carrier aggregation (CA) to aggregate a plurality of base frequency blocks (component carriers) with a system bandwidth (e.g., 20 MHz) of the LTE system as one unit and/or dual connectivity (DC). In addition, the radio communication system 1 may be called SUPER 3G, LTE-A (LTE-Advanced), IMT-Advanced, 4G, 5G, FRA (Future Radio Access) and the like.

The radio communication system 1 as shown in FIG. 8 is provided with a radio base station 11 for forming a macrocell C1, and radio base stations 12a to 12c disposed inside the macrocell C1 to form small cells C2 narrower than the macrocell C1. Further, a user terminal 20 is disposed in the macrocell C1 and each of the small cells C2. A configuration may be made where different numerology is applied between cells. In addition, the numerology refers to design of a signal in some RAT, and a set of communication parameters featuring design of RAT.

The user terminal 20 is capable of connecting to both the radio base station 11 and the radio base station 12. The user terminal 20 is assumed to concurrently use the macrocell C1 and small cell C2 using different frequencies by CA or DC. Further, the user terminal 20 is capable of applying CA or DC using a plurality of cells (CCs) (e.g., 2 or more cells). Furthermore, the user terminal is capable of using a licensed band CC and an unlicensed band CC as a plurality of cells. In addition, it is possible to configure that one of a plurality of cells includes TDD carriers applied with shorted TTI.

The user terminal 20 and radio base station 11 are capable of communicating with each other using carriers (called the existing carrier, Legacy carrier and the like) with a narrow bandwidth in a relatively low frequency band (e.g., 2 GHz). On the other hand, the user terminal 20 and radio base station 12 may use carriers with a wide bandwidth in a relatively high frequency band (e.g., 3.5 GHz, 5 GHz, 30 GHz to 70 GHz, etc.), or may use the same carrier as in the radio base station 11. In addition, the configuration of the frequency band used in each radio base station is not limited thereto.

It is possible to configure so that the radio base station 11 and radio base station 12 (or, two radio base stations 12) undergo wired connection (e.g., optical fiber in conformity with CPRI (Common Public Radio Interface), X2 interface and the like), or wireless connection.

The radio base station 11 and each of the radio base stations 12 are respectively connected to a higher station apparatus 30, and are connected to a core network 40 via the higher station apparatus 30. In addition, for example, the higher station apparatus 30 includes an access gateway apparatus, Radio Network Controller (RNC), Mobility Management Entity (MME) and the like, but is not limited thereto. Further, each of the radio base stations 12 may be connected to the higher station apparatus 30 via the radio base station 11.

In addition, the radio base station 11 is a radio base station having relatively wide coverage, and may be called a macro base station, collection node, eNB (eNodeB), transmission and reception point and the like. Further, the radio base station 12 is a radio base station having local coverage, and may be called a small base station, micro-base station, pico-base station, femto-base station, HeNB (Home eNodeB), RRH (Remote Radio Head), transmission and reception point and the like. Hereinafter, in the case of not distinguishing between the radio base stations 11 and 12, the stations are collectively called a radio base station 10.

Each user terminal 20 is a terminal supporting various communication schemes such as LTE and LTE-A, and may include a fixed communication terminal, as well as the mobile communication terminal.

In the radio communication system 1, as radio access schemes, OFDMA (Orthogonal Frequency Division Multiple Access) is applied on downlink (DL), and SC-FDMA (Single Carrier-Frequency Division Multiple Access) is applied on uplink (UL). OFDMA is a multicarrier transmission scheme for dividing a frequency band into a plurality of narrow frequency bands (subcarriers), and mapping data to each subcarrier to perform communication. SC-FDMA is a single-carrier transmission scheme for dividing a system bandwidth into bands comprised of a single or contiguous resource blocks for each terminal so that a plurality of terminals uses mutually different bands, and thereby reducing interference among terminals. In addition, uplink and downlink radio access schemes are not limited to the combination of the schemes, and OFDMA may be used on UL.

As DL channels, in the radio communication system 1 are used a downlink data channel (also referred to as PDSCH: Physical Downlink Shared Channel, downlink shared channel, etc.) shared by user terminals 20, broadcast channel (PBCH: Physical Broadcast Channel), L1/L2 control channels and the like. User data, higher layer control information, SIB (System Information Block) and the like are transmitted on the PDSCH. Further, MIB (Master Information Block) is transmitted on the PBCH.

The L1/L2 control channel includes downlink control channels (PDCCH (Physical Downlink Control Channel), EPDCCH (Enhanced Physical Downlink Control channel)), PCFICH (Physical Control Format Indicator Channel), PHICH (Physical Hybrid-ARQ Indicator Channel) and the like. The downlink control information (DCI) including scheduling information of the PDSCH and PUSCH and the like is transmitted on the PDCCH. The number of OFDM symbols used in the PDCCH is transmitted on the PCFICH. Receipt confirmation information (ACK/NACK) of HARQ for the PUSCH is transmitted on the PHICH. The EPDCCH is frequency division multiplexed with the PDSCH (downlink shared data channel) to be used in transmitting the DCI and the like as the PDCCH.

As UL channels, in the radio communication system 1 are used an uplink data channel (also referred to as PUSCH: Physical Uplink Shared Channel, etc.) shared by user terminals 20, uplink control channel (PUCCH: Physical Uplink Control Channel), random access channel (PRACH: Physical Random Access Channel) and the like. User data and higher layer control information is transmitted on the PUSCH. Uplink control information (UCI) including at least one of receipt confirmation information (ACK/NACK), radio quality information (CQI) and the like is transmitted on the PUSCH or PUCCH. A random access preamble to establish connection with the cell is transmitted on the PRACH.

### <Radio Base Station>

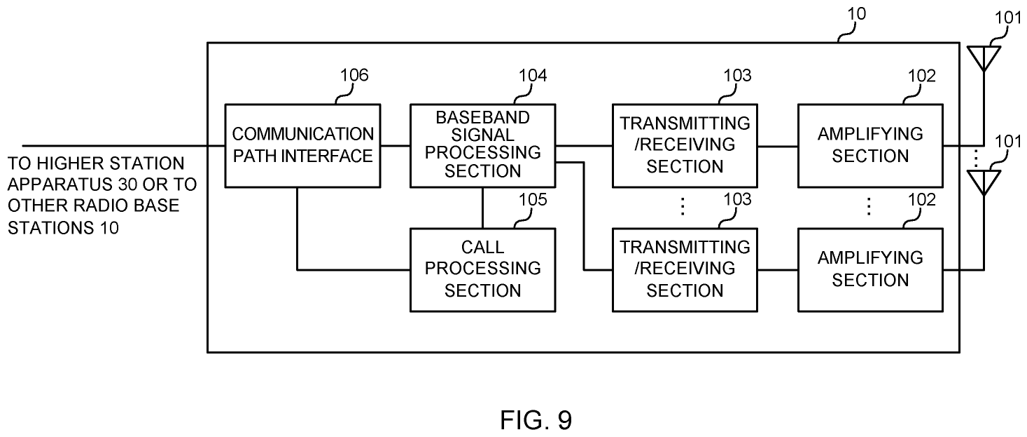

FIG. 9 is a diagram showing one example of an entire configuration of the radio base station according to this Embodiment. The radio base station 10 is provided with a plurality of transmitting/receiving antennas 101, amplifying sections 102, transmitting/receiving sections 103, baseband signal processing section 104, call processing section 105, and communication path interface 106. In addition, with respect to each of the transmitting/receiving antenna 101, amplifying section 102, and transmitting/receiving section 103, the radio base station may be configured to include at least one or more. The radio base station 10 may be a transmitting apparatus of downlink data, and may be a receiving apparatus of uplink data.

Downlink data to transmit to the user terminal 20 from the radio base station 10 is input to the baseband signal processing section 104 from the higher station apparatus 30 via the communication path interface 106.

The baseband signal processing section 104 performs, on the downlink data, transmission processing such as processing of PDCP (Packet Data Convergence Protocol) layer, segmentation and concatenation of the user data, transmission processing of RLC (Radio Link Control) layer such as RLC retransmission control, MAC (Medium Access Control) retransmission control (e.g., transmission processing of HARQ), scheduling, transmission format selection, channel coding, Inverse Fast Fourier Transform (IFFT) processing, and precoding processing to transfer to the transmitting/receiving sections 103. Further, also concerning a downlink control signal, the section 104 performs transmission processing such as channel coding and Inverse Fast Fourier Transform on the signal to transfer to the transmitting/receiving sections 103.

Each of the transmitting/receiving sections 103 converts the baseband signal, which is subjected to pre co di ng for each antenna and is output from the baseband signal processing section 104, into a signal with a radio frequency band to transmit. The radio-frequency signal subjected to frequency conversion in the transmitting/receiving section 103 is amplified in the amplifying section 102, and is transmitted from the transmitting/receiving antenna 101. The transmitting/receiving section 103 is capable of being comprised of a transmitter/receiver, transmitting/receiving circuit or transmitting/receiving apparatus explained based on common recognition in the technical field according to the present invention. In addition, the transmitting/receiving section 103 may be comprised as an integrated transmitting/receiving section, or may be comprised of a transmitting section and receiving section.

On the other hand, for uplink signals, radio-frequency signals received in the transmitting/receiving antennas 101 are amplified in the amplifying sections 102. The transmitting/receiving section 103 receives the uplink signal amplified in the amplifying section 102. The transmitting/receiving section 103 performs frequency conversion on the received signal into a baseband signal to output to the baseband signal processing section 104.

For user data included in the input uplink signal, the baseband signal processing section 104 performs Fast Fourier Transform (FFT) processing, Inverse Discrete Fourier Transform (IDFT) processing, error correcting decoding, reception processing of MAC retransmission control, and reception processing of RLC layer and PDCP layer to transfer to the higher station apparatus 30 via the communication path interface 106. The call processing section 105 performs call processing such as configuration, release and the like of a communication channel, state management of the radio base station 10, management of radio resources and the like.

The communication path interface 106 transmits and receives signals to/from the higher station apparatus 30 via a predetermined interface. Further, the communication path interface 106 may transmit and receive signals (backhaul signaling) to/from another radio base station 10 via an inter-base station interface (e.g., optical fiber in conformity with CPRI (Common Public Radio Interface), X2 interface).

In addition, the transmitting/receiving section 103 transmits downlink signals (e.g., downlink control signal (downlink control channel), downlink data signals (downlink data channel, downlink shared channel), downlink reference signals (DM-FS, CSI-RS, etc.) discovery signal, synchronization signal, broadcast signal, etc.), and receives uplink signals (e.g., uplink control signal (uplink control channel), uplink data signals (uplink data channel, uplink shared channel), uplink reference signals, etc.).

Specifically, the transmitting/receiving section 103 may transmit data in an unlicensed CC (first frequency band). Further, the transmitting/receiving section 103 may transmit RTS (transmission request signal) in the unlicensed CC. Furthermore, the transmitting/receiving section 103 may receive an RTS response signal (response signal to the transmission request signal) in a licensed CC (second frequency band).

Further, the transmitting/receiving section 103 may receive data in the unlicensed CC (first frequency band). Furthermore, the transmitting/receiving section 103 may receive RTS in the unlicensed CC. Still furthermore, in the case of normally receiving the RTS in the unlicensed CC or in the case of detecting an idle state in listening of the unlicensed CC, the transmitting/receiving section 103 may transmit an RTS response signal in the licensed CC (second frequency band).

The transmitting section and receiving section of the present invention are comprised of the transmitting/receiving section 103 and/or communication path interface 106.

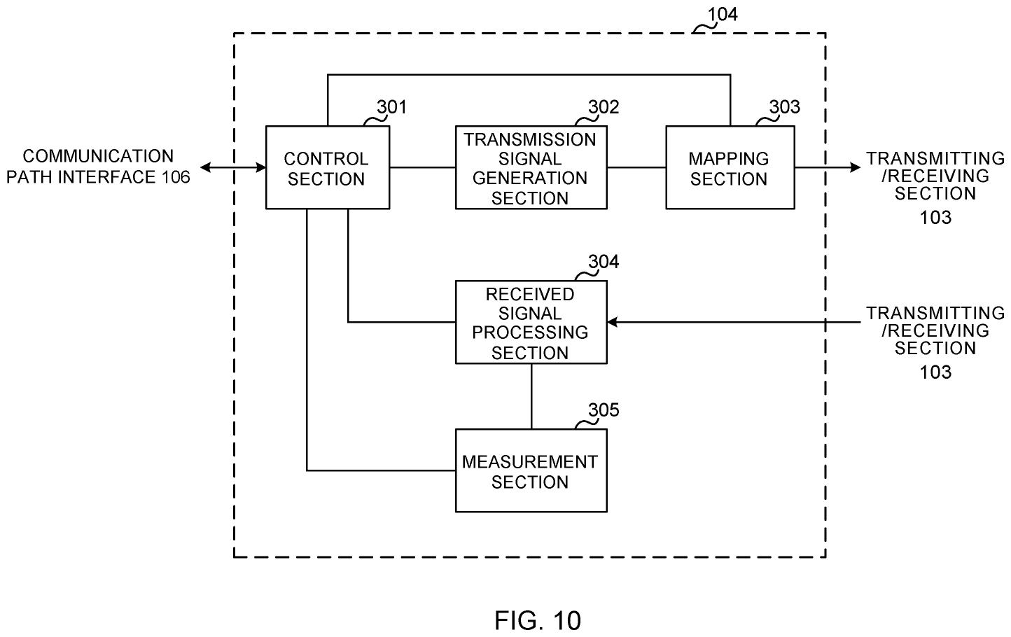

FIG. 10 is a diagram showing one example of a function configuration of the radio base station according to this Embodiment. In addition, FIG. 10 mainly illustrates function blocks of a characteristic portion in this Embodiment, and the radio base station 10 is assumed to also have other function blocks required for radio communication. As shown in FIG. 10, the baseband signal processing section 104 is provided with at least a control section 301, transmission signal generating section 302, mapping section 303, received signal processing section 304, and measurement section 305.

The control section 301 performs control of the entire radio base station 10. The control section 301 is capable of being comprised of a controller, control circuit or control apparatus explained based on the common recognition in the technical field according to the present invention.

For example, the control section 301 controls generation of signals by the transmission signal generating section 302, allocation of signals by the mapping section 303 and the like. Further, the control section 301 controls reception processing of signals by the received signal processing section 304, measurement of signals by the measurement section 305 and the like.

The control section 301 controls scheduling (e.g., resource allocation) of the downlink signal and/or the uplink signal. Specifically, the control section 301 controls the transmission signal generating section 302, mapping section 303 and transmitting/receiving section 103 so as to generate and transmit DCI (DL assignment, DL grant) including the scheduling information of the downlink data channel, and DCI (UL grant) including the scheduling information of the uplink data channel.

Further, the control section 301 may control transmission and/or reception of data in the unlicensed CC. Furthermore, the control section 301 may control transmission and/or reception of the RTS in the unlicensed CC (FIG. 5). Still furthermore, the control section 301 may control transmission and/or reception of the RTS response signal in the licensed CC (FIGS. 4 and 6).

Moreover, the control section 301 may control a frequency band used in transmission of data and/or a frequency band used in transmission of the RTS response signal (FIGS. 5A to 5C). Specifically, the control section 301 may control transmission of data using the frequency band for transmitting the single RTS or at least a part of the total frequency band for transmitting a plurality of RTSs.

Further, based on the detection frequency of a busy state in listening by the transmitting apparatus or the receiving apparatus, the control section 301 may control whether or not to transmit the RTS and/or RTS response signal.

Furthermore, the control section 301 may control listening in the unlicensed CC. In the case of normally receiving the RTS in the unlicensed CC or in the case of detecting an idle state in the listening, the control section 301 may control transmission of the RTS response signal in the licensed CC (FIGS. 4 and 6). The RTS response signal may include a number for identifying the RTS, or a number of a channel beforehand associated with the RTS (FIG. 6).

Based on instructions from the control section 301, the transmission signal generating section 302 generates downlink signals (downlink control channel, downlink data channel, downlink reference signal such as DM-RS, etc.) to output to the mapping section 303. The transmission signal generating section 302 is capable of being comprised of a signal generator, signal generating circuit or signal generating apparatus explained based on the common recognition in the technical field according to the present invention.

Based on instructions from the control section 301, the mapping section 303 maps the downlink signal generated in the transmission signal generating section 302 to predetermined radio resources to output to the transmitting/receiving section 103. The mapping section 303 is capable of being comprised of a mapper, mapping circuit or mapping apparatus explained based on the common recognition in the technical field according to the present invention.

The received signal processing section 304 performs reception processing (e.g., demapping, demodulation, decoding, etc.) on the received signal input from the transmitting/receiving section 103. Herein, for example, the received signal is the uplink signal (uplink control channel, uplink data channel, uplink reference signal, etc.) transmitted from the user terminal 20. The received signal processing section 304 is capable of being comprised of a signal processor, signal processing circuit or signal processing apparatus explained based on the common recognition in the technical field according to the present invention.

The received signal processing section 304 outputs the information decoded by the reception processing to the control section 301. For example, the received signal processing section 304 outputs at least one of a preamble, control information and UL data to the control section 301. Further, the received signal processing section 304 outputs the received signal, signal subjected to the reception processing to the measurement section 305.

The measurement section 305 performs measurement on the received signal. The measurement section 305 is capable of being comprised of a measurement device, measurement circuit or measurement apparatus explained based on the common recognition in the technical field according to the present invention.

For example, the measurement section 305 may measure received power (e.g., RSRP (Reference Signal Received Power)), received quality (e.g., RSRQ (Reference Signal Received Quality)), channel state and the like of the received signal. The measurement result may be output to the control section 301.

### <User Terminal>

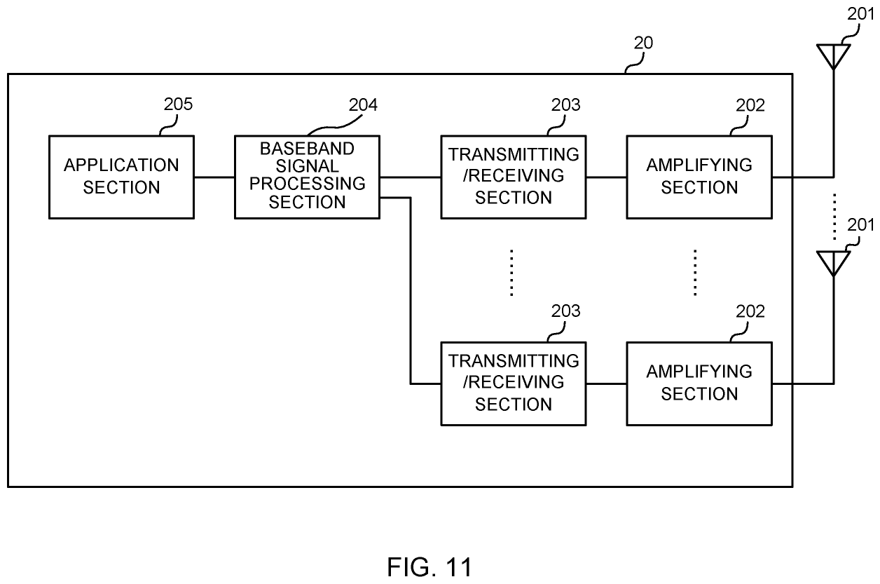

FIG. 11 is a diagram showing one example of an entire configuration of the user terminal according to one Embodiment of the present invention. The user terminal 20 is provided with a plurality of transmitting/receiving antennas 201, amplifying sections 202, transmitting/receiving sections 203, baseband signal processing section 204, and application section 205. In addition, with respect to each of the transmitting/receiving antenna 201, amplifying section 202, and transmitting/receiving section 203, the user terminal may be configured to include at least one or more. The user terminal 20 may be a receiving apparatus of downlink data, and may be a transmitting apparatus of uplink data.

Radio-frequency signals received in the transmitting/receiving antennas 201 are respectively amplified in the amplifying sections 202. Each of the transmitting/receiving sections 203 receives the downlink signal amplified in the amplifying section 202. The transmitting/receiving section 203 performs frequency conversion on the received signal into a baseband signal to output to the baseband signal processing section 204. The transmitting/receiving section 203 is capable of being comprised of a transmitter/receiver, transmitting/receiving circuit or transmitting/receiving apparatus explained based on the common recognition in the technical field according to the present invention. In addition, the transmitting/receiving section 203 may be comprised as an integrated transmitting/receiving section, or may be comprised of a transmitting section and receiving section.

The baseband signal processing section 204 performs FFT processing, error correcting decoding, reception processing of retransmission control and the like on the input baseband signal. Downlink data is transferred to the application section 205. The application section 205 performs processing concerning layers higher than the physical layer and MAC layer, and the like. Further, among the downlink data, system information and higher layer control information is also transferred to the application section 205.

On the other hand, for UL data, the data is input to the baseband signal processing section 204 from the application section 205. The baseband signal processing section 204 performs transmission processing of retransmission control (e.g., transmission processing of HARQ), channel coding, precoding, Discrete Fourier Transform (DFT) processing, IFFT processing and the like to transfer to each of the transmitting/receiving sections 203. Each of the transmitting/receiving sections 203 converts the baseband signal output from the baseband signal processing section 204 into a signal with a radio frequency band to transmit. The radio-frequency signals subjected to frequency conversion in the transmitting/receiving sections 203 are amplified in the amplifying sections 202, and are transmitted from the transmitting/receiving antennas 201, respectively.

In addition, the transmitting/receiving section 203 receives the downlink signals (e.g., downlink control signal (downlink control channel), downlink data signals (downlink data channel, downlink shared channel), downlink reference signals (DM-RS, CSI-RS, etc.) discovery signal, synchronization signal, broadcast signal, etc.), and transmits the uplink signals (e.g., uplink control signal (uplink control channel), uplink data signal (uplink data channel, uplink shared channel), uplink reference signal, etc.).

Specifically, the transmitting/receiving section 203 may transmit data in the unlicensed CC (first frequency band). Further, the transmitting/receiving section 203 may transmit the RTS (transmission request signal) in the unlicensed CC. Furthermore, the transmitting/receiving section 203 may receive the RTS response signal (response signal to the transmission request signal) in the licensed CC (second frequency band).

Further, the transmitting/receiving section 203 may receive the data in the unlicensed CC (first frequency band). Furthermore, the transmitting/receiving section 203 may receive the RTS in the unlicensed CC. Still furthermore, in the case of normally receiving the RTS in listening of the unlicensed CC or in the case of detecting an idle state in listening of the unlicensed CC, the transmitting/receiving section 203 may transmit the RTS response signal in the licensed CC (second frequency band).

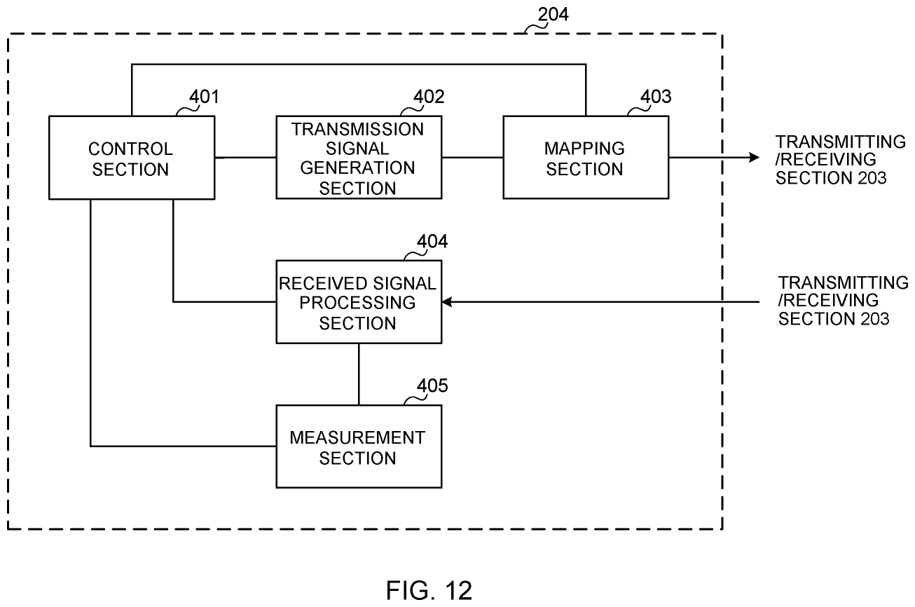

FIG. 12 is a diagram showing one example of a function configuration of the user terminal according to this Embodiment. In addition, FIG. 12 mainly illustrates function blocks of a characteristic portion in this Embodiment, and the user terminal 20 is assumed to also have other function blocks required for radio communication. As shown in FIG. 12, the baseband signal processing section 204 that the user terminal 20 has is provided with at least a control section 401, transmission signal generating section 402, mapping section 403, received signal processing section 404, and measurement section 405.

The control section 401 performs control of the entire user terminal 20. The control section 401 is capable of being comprised of a controller, control circuit or control apparatus explained based on the common recognition in the technical field according to the present invention.

For example, the control section 401 controls generation of signals by the transmission signal generating section 402, allocation of signals by the mapping section 403 and the like. Further, the control section 401 controls reception processing of signals by the received signal processing section 404, measurement of signals by the measurement section 405 and the like.

Further, the control section 401 may control transmission and/or reception of data in the unlicensed CC. Furthermore, the control section 401 may control transmission and/or reception of the RTS in the unlicensed CC (FIG. 5). Still furthermore, the control section 401 may control transmission and/or reception of the RTS response signal in the licensed CC (FIGS. 4 and 6).

Moreover, the control section 401 may control a frequency band used in transmission of data and/or a frequency band used in transmission of the RTS response signal (FIGS. 5A to 5C). Specifically, the control section 401 may control transmission of data using the frequency band for transmitting the single RTS or at least a part of the total frequency band for transmitting a plurality of RTSs.

Further, based on the detection frequency of a busy state in listening by the transmitting apparatus or the receiving apparatus, the control section 401 may control whether or not to transmit the RTS and/or RTS response signal.

Furthermore, the control section 401 may control listening in the unlicensed CC. In the case of normally receiving the RTS in listening of the unlicensed CC or in the case of detecting an idle state in the listening, the control section 401 may control transmission of the RTS response signal in the licensed CC (FIGS. 4 and 6). The RTS response signal may include a number for identifying the RTS, or a number of a channel beforehand associated with the RTS (FIG. 6).

Based on instructions from the control section 401, the transmission signal generating section 402 generates uplink signals (uplink control channel, uplink data channel, uplink reference signal, etc.) to output to the mapping section 403. The transmission signal generating section 402 is capable of being comprised of a signal generator, signal generating circuit or signal generating apparatus explained based on the common recognition in the technical field according to the present invention.

Based on instructions from the control section 401, the transmission signal generating section 402 generates the uplink data channel. For example, when the downlink control channel notified from the radio base station 10 includes the UL grant, the transmission signal generating section 402 is instructed to generate the uplink data channel from the control section 401.

Based on instructions from the control section 401, the mapping section 403 maps the uplink signal generated in the transmission signal generating section 402 to radio resources to output to the transmitting/receiving section 203. The mapping section 403 is capable of being comprised of a mapper, mapping circuit or mapping apparatus explained based on the common recognition in the technical field according to the present invention.

The received signal processing section 404 performs reception processing (e.g. demapping, demodulation, decoding, etc.) on the received signal input from the transmitting/receiving section 203. Herein, for example, the received signal is the downlink signal (downlink control signal, downlink data signal, downlink reference signal, etc.) transmitted from the radio base station 10. The received signal processing section 404 is capable of being comprised of a signal processor, signal processing circuit or signal processing apparatus explained based on the common recognition in the technical field according to the present invention. Further, the received signal processing section 404 is capable of constituting the receiving section according to the present invention.

Based on instructions from the control section 401, the received signal processing section 404 performs blind decoding on the downlink control channel for scheduling transmission and/or reception of the downlink data channel, and based on the DCI, performs reception processing on the downlink data channel. Further, the received signal processing section 404 estimates channel gain based on the DM-RS or CRS, and based on the estimated channel gain, demodulates the downlink data channel.

The received signal processing section 404 outputs the information decoded by the reception processing to the control section 401. For example, the received signal processing section 404 outputs the broadcast information, system information, RRC signaling, DCI and the like to the control section 401. The received signal processing section 404 may output a decoding result of the data to the control section 401. Further, the received signal processing section 404 outputs the received signal and signal subjected to the reception processing to the measurement section 405.

The measurement section 405 performs measurement on the received signal. The measurement section 405 is capable of being comprised of a measurement device, measurement circuit or measurement apparatus explained based on the common recognition in the technical field according to the present invention.

For example, the measurement section 405 may measure receive power (e.g., RSRP), DL received quality (e.g., RSRQ), channel state and the like of the received signal. The measurement result maybe output to the control section 401.

### <Hardware Configuration>

In addition, the block diagrams used in explanation of the above-mentioned Embodiment show blocks on a function-by-function basis. These function blocks (configuration sections) are actualized by any combination of hardware and/or software. Further, the means for actualizing each function block is not limited particularly. In other words, each function block may be actualized using a single apparatus combined physically and/or logically, or two or more apparatuses that are separated physically and/or logically are connected directly and/or indirectly (e.g., using cable and/or radio), and each function block may be actualized using a plurality of these apparatuses.

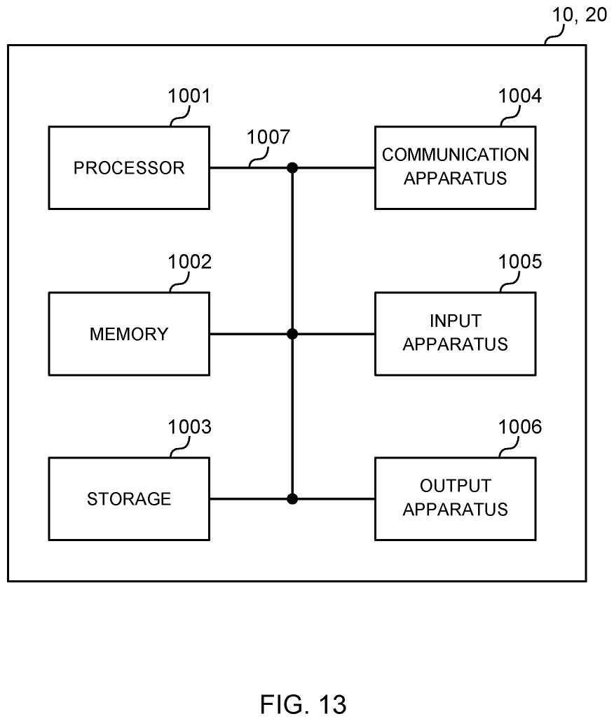

For example, each of the radio base station, user terminal and the like in one Embodiment of the present invention may function as a computer that performs the processing of the radio communication method of the invention. FIG. 13 is a diagram showing one example of a hardware configuration of each of the radio base station and user terminal according to one Embodiment of the invention. Each of the radio base station 10 and user terminal 20 as described above may be physically configured as a computer apparatus including a processor 1001, memory 1002, storage 1003, communication apparatus 1004, input apparatus 1005, output apparatus 1006, bus 1007 and the like.

In addition, in the following description, it is possible to replace the letter of “apparatus” with a circuit, device, unit and the like to read. With respect to each apparatus shown in the figure, the hardware configuration of each of the radio base station 10 and the user terminal 20 may be configured so as to include one or a plurality of apparatuses, or may be configured without including a part of apparatuses.

For example, a single processor 1001 is shown in the figure, but a plurality of processors may exist. Further, the processing may be executed by a single processor, or may be executed by one or more processors at the same time, seguentially or using another technique. In addition, the processor 1001 may be implemented on one or more chips.

For example, each function in the radio base station 10 and user terminal 20 is actualized in a manner such that predetermined software (program) is read on the hardware of the processor 1001, memory 1002 and the like, and that the processor 1001 thereby performs computations, and controls communication via the communication apparatus 1004, and read and/or write of data in the memory 1002 and storage 1003.

For example, the processor 1001 operates an operating system to control the entire computer. The processor 1001 may be comprised of a Central Processing Unit (CPU) including interfaces with peripheral apparatuses, control apparatus, computation apparatus, register and the like. For example, the above-mentioned baseband signal processing section 104 (204), call processing section 105 and the like may be actualized by the processor 1001.

Further, the processor 1001 reads the program (program code), software module, data and the like on the memory 1002 from the storage 1003 and/or the communication apparatus 1004, and according thereto, executes various kinds of processing. Used as the program is a program that causes the computer to execute at least apart of operation described in the above-mentioned Embodiment. For example, the control section 401 of the user terminal 20 may be actualized by a control program stored in the memory 1002 to operate in the processor 1001, and the other function blocks may be actualized similarly.

The memory 1002 is a computer-readable storage medium, and for example, may be comprised of at least one of ROM (Read Only Memory), EPROM (Erasable Programmable ROM), EEPROM (Electrically EPROM), RAM (Random Access Memory) and other proper storage media. The memory 1002 may be called the register, cache, main memory (main storage apparatus) and the like. The memory 1002 is capable of storing the program (program code), software module and the like executable to implement the radio communication method according to one Embodiment of the present invention.

The storage 1003 is a computer-readable storage medium, and for example, may be comprised of at least one of a flexible disk, floppy (Registered Trademark) disk, magneto-optical disk (e.g., compact disk (CD-ROM (Compact Disc ROM), etc.), digital multi-purpose disk, Blu-ray (Registered Trademark) disk), removable disk, hard disk drive, smart card, flash memory device (e.g., card, stick, key drive), magnetic stripe, database, server and other proper storage media. The storage 1003 may be called an auxiliary storage apparatus.

The communication apparatus 1004 is hardware (transmitting/receiving device) to perform communication between computers via a wired and/or wireless network, and for example, is also referred to as a network device, network controller, network card, communication module and the like. For example, in order to actualize Frequency Division Duplex (FDD) and/or Time Division Duplex (TDD), the communication apparatus 1004 may be comprised by including a high-frequency switch, duplexer, filter, frequency synthesizer and the like. For example, the transmitting/receiving antenna 101 (201), amplifying section 102 (202), transmitting/receiving section 103 (203), communication path interface 106 and the like as described above may be actualized by the communication apparatus 1004.

The input apparatus 1005 is an input device (e.g., keyboard, mouse, microphone, switch, button, sensor, etc.) that receives input from the outside. The output apparatus 1006 is an output device (e.g., display, speaker, LED (Light Emitting Diode) lamp, etc.) that performs output to the outside. In addition, the input apparatus 1005 and output apparatus 1006 may be an integrated configuration (e.g., touch panel).

Further, each apparatus of the processor 1001, memory 1002 and the like is connected on the bus 1007 to communicate information. The bus 1007 may be configured using a single bus, or may be configured using different buses between apparatuses.

Furthermore, each of the radio base station 10 and user terminal 20 may be configured by including hardware such as a microprocessor, Digital Signal Processor (DSP), ASIC (Application Specific Integrated Circuit), PLD (Programmable Logic Device), and FP GA (Field Programmable Gate Array), or a part or the whole of each function block may be actualized using the hardware. For example, the processor 1001 may be implemented using at least one of the hardware.

### (Modification)

In addition, the term explained in the present Description and/or the term required to understand the present Description may be replaced with a term having the same or similar meaning. For example, the channel and/or the symbol may be a signal (signaling). Further, the signal may be a message. The reference signal is capable of being abbreviated as RS (Reference Signal), and according to the standard to apply, may be called a pilot, pilot signal and the like. Furthermore, the component carrier (CC) may be called a cell, frequency carrier, carrier frequency and the like.

Further, the radio frame may be comprised of one or a plurality of frames in the time domain. The one or each of the plurality of frames constituting the radio frame may be called a subframe. Furthermore, the subframe may be comprised of one or a plurality of slots in the time domain. The subframe may be a fixed time length (e.g., 1 ms) that is not dependent on numerology.

Furthermore, the slot may be comprised of one or a plurality of symbols (OFDM (Orthogonal Frequency Division Multiplexing) symbols, SC-FDMA (Single Carrier Frequency Division Multiple Access) symbols and the like) in the time domain. Still furthermore, the slot may a time unit based on numerology. Moreover, the slot may include a plurality of mini-slots. Each mini-slot may be comprised of one or a plurality of symbols in the time domain. Further, the mini-slot may be called a subslot.

Each of the radio frame, subframe, slot, mini-slot and symbol represents a time unit in transmitting a signal. For the radio frame, subframe, slot, mini-slot and symbol, another name corresponding to each of them may be used. For example, one subframe may be called Transmission Time Interval (TTI), a plurality of contiguous subframes may be called TTI, or one slot or one mini-slot may be called TTI. In other words, the subframe and/or TTI may be the subframe (1 ms) in existing LTE, may be a frame (e.g., 1 to 13 symbols) shorter than 1 ms, or may be a frame longer than 1 ms. In addition, instead of the subframe, the unit representing the TTI may be called the slot, mini-slot and the like.

Herein, for example, the TTI refers to a minimum time unit of scheduling in radio communication. For example, in the LTE system, the radio base station performs scheduling for allocating radio resources (frequency bandwidth, transmit power and the like capable of being used in each user terminal) to each user terminal in a TTI unit. In addition, the definition of the TTI is not limited thereto.

The TTI may be a transmission time unit of a data packet (transport block) subjected to channel coding, code block and/or codeword, or may be a processing unit of scheduling, link adaptation and the like. In addition, when the TTI is given, a time segment (e.g., the number of symbols) to which the transport block, code block and/or codeword is actually mapped may be shorter than the TTI.

In addition, when one slot or one mini-slot is called the TTI, one or more TTIs (i.e., one or more slots, or one or more mini-slots) may be the minimum time unit of scheduling. Further, the number of slots (the number of mini-slots) constituting the minimum time unit of scheduling may be controlled.

The TTI having a time length of 1 ms may be called ordinary TTI (TTI in LTE Rel.8-12), normal TTI, long TTI, ordinary subframe, normal subframe, long subframe or the like. The TTI shorter than the ordinary TTI may be called shortened TTI, short TTI, partial or fractional TTI, shortened subframe, short subframe, mini-slot, subslot or the like.

In addition, the long TTI (e.g., ordinary TTI, subframe, etc.) may be read with TTI having a time length exceeding 1 ms, and the short TTI (e.g., shortened TTI, etc.) may be read with TTI having a TTI length of 1 ms or more and less than the TTI length of the long TTI.

The resource block (RB) is a resource allocation unit in the time domain and frequency domain, and may include one or a plurality of contiguous subcarriers in the frequency domain. Further, the RB may include one or a plurality of symbols in the time domain, and may be a length of 1 slot, 1 mini-slot, 1 subcarrier, or 1 TTI. Each of 1 TTI and 1 subframe may be comprised of one or a plurality of resource blocks. In addition, one or a plurality of RBs may be called a physical resource block (PRB: Physical RB), subcarrier group (SCG: Sub-Carrier Group), resource element group (REG), PRB pair, RB pair and the like.

Further, the resource block may be comprised of one or a plurality of resource elements (RE: Resource Element). For example, 1 RE may be a radio resource region of 1 subcarrier and 1 symbol.

In addition, structures of the above-mentioned radio frame, subframe, slot, mini-slot, symbol and the like are only illustrative. For example, it is possible to modify, in various manners, configurations of the number of subframes included in the radio frame, the number of slots per subframe or radio frame, the number of mini-slots included in the slot, the numbers of symbols and RBs included in the slot or mini-slot, the number of sub carriers included in the RB, the number of symbols within the TTI, the symbol length, the cyclic prefix (CP) length and the like.

Further, the information, parameter and the like explained in the present Description may be expressed using an absolute value, may be expressed using a relative value from a predetermined value, or may be expressed using another corresponding information. For example, the radio resource may be indicated by a predetermined index.

The names used in the parameter and the like in the present Description are not restrictive names in any respects. For example, it is possible to identify various channels (PUCCH (Physical Uplink Control Channel), PDCCH (Physical Downlink Control Channel) and the like) and information elements, by any suitable names, and therefore, various names assigned to these various channels and information elements are not restrictive names in any respects.

The information, signal and the like explained in the present Description may be represented by using any of various different techniques. For example, the data, order, command, information, signal, bit, symbol, chip and the like capable of being described over the entire above-mentioned explanation may be represented by voltage, current, electromagnetic wave, magnetic field or magnetic particle, optical field or photon, or any combination thereof.

Further, the information, signal and the like are capable of being output from a higher layer to a lower layer, and/or from the lower layer to the higher layer. The information, signal and the like may be input and output via a plurality of network nodes.

The input/output information, signal and the like may be stored in a particular place (e.g., memory), or may be managed using a management table. The input/output information, signal and the like are capable of being rewritten, updated or edited. The output information, signal and the like may be deleted. The input information, signal and the like may be transmitted to another apparatus.

Notification of the information is not limited to the Aspects/Embodiment described in the present Description, and may be performed using another method. For example, notification of the information may be performed using physical layer signaling (e.g., Downlink Control Information (DCI), Uplink Control Information (UCI)), higher layer signaling (e.g., RRC (Radio Resource Control) signaling, broadcast information (Master Information Block (MIB), System Information Block (SIB) and the like), MAC (Medium Access Control) signaling), other signals, or combination thereof.

In addition, the physical layer signaling may be called L1/L2 (Layer 1/Layer 2) control information (L1/L2 control signal), L1 control information (L1 control signal) and the like. Further, the RRC signaling may be called RRC message, and for example, may be RRC connection setup (RRC Connection Setup) message, RRC connection reconfiguration (RRC Connection Reconfiguration) message, and the like. Furthermore, for example, the MAC signaling may be notified using MAC Control Element (MAC CE).

Further, notification of predetermined information (e.g., notification of “being X”) is not limited to explicit notification, and may be performed implicitly (e.g., notification of the predetermined information is not performed, or by notification of different information).

The decision may be made with a value (“0” or “1”) expressed by 1 bit, may be made with a Boolean value represented by true or false, or may be made by comparison with a numerical value (e.g., comparison with a predetermined value).

Irrespective of that the software is called software, firmware, middle-ware, micro-code, hardware descriptive term, or another name, the software should be interpreted widely to mean a command, command set, code, code segment, program code, program, sub-program, software module, application, software application, software package, routine, sub-routine, object, executable file, execution thread, procedure, function and the like.

Further, the software, command, information and the like may be transmitted and received via a transmission medium. For example, when the software is transmitted from a website, server or another remote source using wired techniques (coaxial cable, optical fiber cable, twisted pair, Digital Subscriber Line (DSL) and the like) and/or wireless techniques (infrared, microwave and the like), these wired techniques and/or wireless techniques are included in the definition of the transmission medium.

The terms of “system” and “network” used in the present Description are capable of being used interchangeably.

In the present Description, the terms of “Base Station (BS)”, “radio base station”, “eNB”, “gNB”, “cell”, “sector”, “cell group”, “carrier” and “component carrier” are capable of being used interchangeably. There is the case where the base station is called by the terms of fixed station, NodeB, eNodeB (eNB), access point, transmission point, reception point, transmission and reception point, femto-cell, small cell and the like.

The base station is capable of accommodating one or a plurality of (e.g., three) cells (also called the sector). When the base station accommodates a plurality of cells, the entire coverage area of the base station is capable of being segmented into a plurality of smaller areas, and each of the smaller areas is also capable of providing communication services by a base station sub-system (e.g., small base station (RRH: Remote Radio Head) for indoor use). The term of “cell” or “sector” refers to a part or the whole of coverage area of the base station and/or base station sub-system that performs communication services in the coverage.

In the present Description, the terms of “Mobile Station (MS)”, “user terminal”, “User Equipment (UE)”, and “terminal” are capable of being used interchangeably.

There is the case where the Mobile Station may be called using a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terms, by a person skilled in the art.

The base station and/or mobile station may be called the transmitting apparatus, receiving apparatus and the like.

Further, the radio base station in the present Description may be read with the user terminal. For example, each Aspect/Embodiment of the present invention may be applied to a configuration where communication between the radio base station and the user terminal is replaced with communication among a plurality of user terminals (D2D: Device-to-Device). In this case, the functions that the above-mentioned radio base station 10 has may be the configuration that the user terminal 20 has. Further, the words of “up”, “down” and the like may be read with “side”. For example, the uplink channel may be read with a side channel.

Similarly, the user terminal in the present Description may be read with the radio base station. In this case, the functions that the above-mentioned user terminal 20 has may be the configuration that the radio base station 10 has.

In the present Description, operation performed by the base station may be performed by an upper node thereof in some case. In a network including one or a plurality of network nodes having the base station, it is obvious that various operations performed for communication with the terminal are capable of being performed by the base station, one or more network nodes (e.g., MME (Mobility Management Entity), S-GW (Serving-Gateway) and the like are considered, but the invention is not limited thereto) except the base station, or combination thereof.

Each Aspect/Embodiment explained in the present Description may be used alone, may be used in combination, or may be switched and used according to execution. Further, with respect to the processing procedure, sequence, flowchart and the like of each Aspect/Embodiment explained in the present Description, unless there is a contradiction, the order may be changed. For example, with respect to the methods explained in the present Description, elements of various steps are presented in illustrative order, and are not limited to the presented particular order.

Each Aspect/Embodiment explained in the present Description may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (Registered Trademark) (Global System for Mobile communications), CDMA 2000, UMB (Ultra Mobile Broadband), IEEE 802.11 (Wi-Fi (Registered Trademark)), IEEE 802.16 (WiMAX (Registered Trademark)), IEEE 802.20, UWB (Ultra-WideBand), Bluetooth (Registered Trademark), system using another proper radio communication method and/or the next-generation system extended based thereon.

The description of “based on” used in the present Description does not mean “based on only”, unless otherwise specified. In other words, the description of “based on” means both of “based on only” and “based on at least”.

Any references to elements using designations of “first”, “second” and the like used in the present Description do not limit the amount or order of these elements overall. These designations are capable of being used in the present Description as the useful method to distinguish between two or more elements. Accordingly, references of first and second elements do not mean that only two elements are capable of being adopted, or that the first element should be prior to the second element in any manner.

There is the case where the term of “determining” used in the present Description includes various types of operation. For example, “determining” may be regarded as “determining” calculating, computing, processing, deriving, investigating, looking up (e.g., looking up in a table, database or another data structure), ascertaining and the like. Further, “determining” may be regarded as “determining” receiving (e.g., receiving information), transmitting (e.g., transmitting information), input, output, accessing (e.g., accessing data in memory) and the like. Furthermore, “determining” may be regarded as “determining” resolving, selecting, choosing, establishing, comparing and the like. In other words, “determining” may be regarded as “determining” some operation.

The terms of “connected” and “coupled” used in the present Description or any modifications thereof mean direct or indirect every connection or coupling among two or more elements, and are capable of including existence of one or more intermediate elements between two mutually “connected” or “coupled” elements. Coupling or connection between elements may be physical, maybe logical or may be combination thereof. For example, “connection” may be read with “access”.

In the present Description, in the case where two elements are connected, it is possible to consider that two elements are mutually “connected” or “coupled”, by using one or more electric wires, cable and/or print electric connection, and as some non-limited and non-inclusive examples, electromagnetic energy having wavelengths in a radio frequency region, microwave region and/or light (both visible and invisible) region, or the like.

In the present Description, the terms of “A and B are different” may mean that “A and B are different from each other”. The terms of “separate”, “coupled” and the like may be similarly interpreted.

In the case of using “including”, “comprising” and modifications thereof in the present Description or the scope of the claims, as in the term of “provided with”, these terms are intended to be inclusive. Further, the term of “or” used in the present Description or the scope of the claims is intended to be not exclusive OR.

As described above, the present invention is described in detail, but it is obvious to a person skilled in the art that the invention is not limited to the Embodiment described in the present Description. The invention is capable of being carried into practice as modified and changed aspects without departing from the subject matter and scope of the invention defined by the descriptions of the scope of the claims. Accordingly, the descriptions of the present Description are intended for illustrative explanation, and do not provide the invention with any restrictive meaning.

1. A transmitting apparatus that transmits data in a first frequency band, comprising:
a transmitting section that transmits a transmission request signal of the data in the first frequency band;
a receiving section that receives a response signal to the transmission request signal in a second frequency band; and
a control section that controls transmission of the data based on the response signal.

2. The transmitting apparatus according to claim 1, wherein the transmitting section transmits the transmission request signal in a frequency band used in transmission of the data.

3. The transmitting apparatus according to claim 1, wherein the transmission request signal is a single transmission request signal, or a plurality of transmission request signals subjected to frequency multiplexing, and
the control section transmits the data, in a frequency band for transmitting the single transmission request signal, or in at least a part of a total frequency band for transmitting the plurality of transmission request signals.

4. The transmitting apparatus according to claim 1, wherein the response signal includes a number for identifying the transmission request signal, or a number of a channel beforehand associated with the transmission request signal.

5. The transmitting apparatus according to claim 1, wherein based on a detection frequency of a busy state in listening by the transmitting apparatus or a receiving apparatus of the data, the control section controls whether or not to transmit the transmission request signal.

6. A receiving apparatus that receives data in a first frequency band, comprising:
a receiving section that receives a transmission request signal of the data in the first frequency band; and
a transmitting section that transmits a response signal to the transmission request signal in a second frequency band, in a case of normally receiving the transmission request signal in the first frequency band, or in another case of detecting an idle state in listening of the first frequency band.

7. The transmitting apparatus according to claim 2, wherein the response signal includes a number for identifying the transmission request signal, or a number of a channel beforehand associated with the transmission request signal.

8. The transmitting apparatus according to claim 3, wherein the response signal includes a number for identifying the transmission request signal, or a number of a channel beforehand associated with the transmission request signal.

9. The transmitting apparatus according to claim 2, wherein based on a detection frequency of a busy state in listening by the transmitting apparatus or a receiving apparatus of the data, the control section controls whether or not to transmit the transmission request signal.

10. The transmitting apparatus according to claim 3, wherein based on a detection frequency of a busy state in listening by the transmitting apparatus or a receiving apparatus of the data, the control section controls whether or not to transmit the transmission request signal.

11. The transmitting apparatus according to claim 4, wherein based on a detection frequency of a busy state in listening by the transmitting apparatus or a receiving apparatus of the data, the control section controls whether or not to transmit the transmission request signal.
